(19) United States
(12) Patent Application Publication
(10) Pub. No.: US 2005/0110788 A1
(43) Pub. Date: May 26, 2005

(54) Handling of image data created by manipulation of image data sets

(76) Inventors: David N. Turner, Edinburgh (GB); Andrew John Bissell, Edinburgh (GB); Matthew Barish, Edinburgh (GB); Richard Moffett, Anderson Place (GB); Pavios Papageorgiou, Edinburgh (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/496,468

(22) PCT Filed: Nov. 13, 2002
(86) PCT No.: PCT/GB02/05108

(30) Foreign Application Priority Data
Nov. 23, 2001 (GB) 0128145.0

(51) Int. Cl. G06T 15/00; G09G 5/00

(52) U.S. Cl. 345/419; 345/619

(57) ABSTRACT

A computer program product for image manipulation of a source data set, the product being operable to: load a source data set, for example of voxel data, for image manipulation by the computer program product; generate and display image data of the source data set by allowing interactive user adjustment of a plurality of operational state conditions; and store the image data of a currently displayed image together with operational state data corresponding to at least a subset of its current operational state conditions in a standard image data format, such as DICOM. Storing operational state data with the image data allows a user later to reload the image data and return the computer program's other important configuration settings, so that a user can seamlessly continue with an interrupted session, either on the same workstation, or on a different workstation at a remote location. This is a major improvement for medical imaging applications, since hospital networks are generally incapable of supporting general-purpose file transfer.

### BACKGROUND OF THE INVENTION

The invention relates to imaging handling, more specifically to handling of scanned images, such as are obtained from medical imaging equipment.

The majority of medical diagnostic imaging today is done using digital devices. Such devices fall into three groups. Firstly, acquisition devices, such as computerised tomography (CT), magnetic resonance (MR), positron emission tomography (PET), some ultrasound, some X-ray angiography, or computed radiography (CR)/digital radiography (DR) devices. These devices measure physical properties over a region of a subject and store the measurements digitally as image data or other data. Secondly, diagnostic devices, such as 3-D workstations, picture archiving and communication system (PACS) workstations, teleradiology workstations, or specialist treatment planning workstations. These devices do not acquire data but allow a physician to interpret, manipulate and analyse previously obtained data. Thirdly, hybrid devices, such as most ultrasound scanners, CT or X-ray fluoroscopy systems, open MR scanners, or some X-ray angiography systems. These devices measure physical properties over a region of a subject and then immediately present the information as images to the physician. Hybrid devices have both an acquisition and a diagnostic function. The term diagnostic devices shall hereinafter be used to indicate both diagnostic devices themselves as well as the diagnostic aspects of hybrid devices.

The majority of diagnostic devices are complex to operate. Furthermore, with ever increasing feature sets there is an ever increasing complexity. In analysing a 3-D data set, a user may have to perform numerous operations to display the data in the most appropriate form. These steps might include choosing parameters for volume rendering, such as colour, contrast, signal display range etc., identifying and excluding irrelevant aspects of the anatomy from view, selection of a suitable viewpoint and illumination direction and possibly identifying and highlighting components within the data set of specific interest.

It can therefore take even a skilled user a considerable amount of time to generate what the they perceive to be the most appropriate representations of the data set, this may also include providing additional information to assist accurate diagnosis. Furthermore, because the process is inherently partially subjective, different users manipulating the same data set with identical diagnostic devices or stand-alone computer workstations will often provide significantly different final images. Accordingly, without a thorough description of the steps involved in manipulating a particular data set to provide a given image, there is a wide scope for possible misinterpretation of that image. This is particularly so in cases where an image is viewed by somebody other than the original creator. It can also be difficult and time consuming for a user to exactly recreate a previously created image from a raw data set.

To ameliorate these problems it is desirable to save details of the presentation and operational state of the computer workstation. This can then be used during subsequent viewing of the data set, or transmitted to another user for consultation.

Currently, this process is performed as follows; a first user operates the device to generate diagnostically useful images and/or measurements. The first user then saves relevant information pertaining to the current image state to a computer file to which the first user attributes a unique name. The first user can subsequently stop using the computer workstation, or use it for another purpose. Should the first user need to do further work on the study, they must locate the saved state file to restore it in connection with the original data set.

If required, the first user can transfer the file to a second user with the original image data of the study. The second user is able to restore the image generated by the first user on their own computer workstation, and the first and second users can collaborate.

One drawback of this process is that a user must deal with the tedious aspects of creating and transmitting large binary files using only the relatively basic tools which are provided by the operating systems of typical diagnostic devices. General-purpose file transfer is not an expected or standard feature of diagnostic devices and such devices often offer very poor or no facilities for file transfer.

Accordingly, there is a need in the art for a method of storing the instantaneous state information of diagnostic devices in a manner which is easy to implement, and more amenable to transfer between different diagnostic devices and other stand-alone computer workstations in a hospital network that generally does not support general-purpose file transfer, but only file transfer of one or more standard image data formats.

### SUMMARY OF THE INVENTION

According to an aspect of the invention there is provided a computer program product for image manipulation of a source data set, the product being operable to: load a source data set for image manipulation by the computer program product; generate and display image data of the source data set by allowing interactive user adjustment of a plurality of operational state conditions; and store the image data of a currently displayed image together with operational state data corresponding to at least a subset of its current operational state conditions in a standard image data format.

Storing operational state data with the image data allows a user later to reload the image data and return the computer program's other important configuration settings, so that a user can seamlessly continue with an interrupted session, either on the same workstation, or on a different workstation at a remote location. A key factor for medical imaging applications is that hospital networks are generally incapable of supporting general-purpose file transfer. General-purpose file transfer is not an expected or standardised feature of diagnostic devices and associated networks. Often such devices and networks only support transfer of files that conform to a standard file format, such as DICOM. Embedding the operational state data in a standard image data format file therefore guarantees transportability of the operational state data with the image data provided that the hospital network, or other network, supports the chosen standard file format.

The approach of the invention thus overcomes the problems presented by networks that have very poor or no general file transfer facilities which are prevalent in the medical sector. The present invention thus allows operational state data to be stored and communicated through any system designed to store and communicate digital image data, including existing storage and communication systems. For example, systems for storing and communicating digital medical image data using the DICOM standard are widespread and expected to eventually completely replace legacy systems.

The image data and the operational state data can be stored in a single file conforming to the standard image data format.

In one embodiment, the standard image data format comprises a file structure having a header portion and an image data portion, and wherein the image data is stored in the image data portion, and the operational state data is stored in the header portion. Moreover, the standard image data format comprises a file structure having a header portion and an image data portion, and wherein the image data and at least a part of the operational state data are stored in the image data portion.

In another embodiment, the image data and the operational state data are stored in multiple files conforming to the standard image data format which are linked by association. The standard image data format may comprise a file structure having a header portion and an image data portion, wherein the image data is stored in the image data portion of a first one of the multiple files and at least a part of the operational state data is stored in the image data portion of a second one of the multiple files. The second one of the multiple files may contain notice data which provides a user-readable notice when the second file is displayed, so that a user is provided with a notification that the second file is not to be deleted.

Each of the multiple files may contain demographic tags to associate them with each other.

When operational state data is stored in the image data portion it may be stored with a reduced range of bits per image pixel, to provide a muted image if the operational state data is displayed.

A computer program product according to any one of the preceding claims further operable to: allow user selection of a stored file group comprising, at least one file, the at least one file conforming to the standard image data format, the file group containing image data of a previously displayed image and its operational state data; and in response thereto reload the image data and display the associated image and restore the computer program product to a state corresponding to the operational state data.

Moreover the computer program product may be further operable to: reload a source data set pointed to by the stored file so as to allow interactive user adjustment of the operational state conditions starting from those prevailing at the time of storage of the reloaded image.

The reload may be performed after, before, or concurrently with, the display of the image data. Preferably the reload is performed after or concurrently with the display of the image data since the source data set is usually a large body of data in comparison to the image data and operational state data. Typically, any time lag in reloading the source data set will be shorter than the time needed by the user to perform an initial visual analysis of the image data, in which case the latency of the source data set reload will carry no penalty in terms of user perception. Once the source data set has been reloaded, the fact that the operational state data has restored the important operational state conditions allows the user to seamlessly modify the image displayed, taking it away from the stored image. For example, the user can rotate the view away from the stored view direction, or change the lighting parameters, or adjust the opacity function from the state it had when the image was saved in the previous session. This is a great improvement on existing functionality of image manipulation software in the medical imaging field.

The standard image data format can be DICOM or another standard. In embodiments in which DICOM file format is used, the operational state data can be stored partially or wholly in so-called proprietary or private tags in the header portion.

The image data may comprise a plurality of image frames to be displayed in sequence to generate an animation, the operational state data being generic to the image frames.

The source data set may be a source data set, i.e. a 3-D data set, or a data set of lower or higher dimensionality.

The operational state data may comprise at least one of: volume rendering parameters; surface rendering parameters; segmentation data; view direction parameters; graphical user interface configuration data; clipping information; and multi-planar reformatting (MPR) parameters. Volume rendering parameters might include opacity and colour settings. Surface rendering parameters may be threshold data. It will be appreciated that many other operational state conditions may be included in the operational state data.

According to another aspect of the invention there is provided a computer apparatus loaded with a computer program product as described above.

Another aspect of the invention provides a computer-implemented method, comprising: loading a source data set for image manipulation into a computer apparatus; generating and displaying image data of the source data set by allowing interactive user adjustment of a plurality of operational state conditions; and storing the image data of a currently displayed image together with operational state data corresponding to at least a subset of its operational state conditions in a standard image data format.

A computer-implemented method, comprising: running a computer program product for image manipulation of source data sets on a computer apparatus; allowing user selection of a stored file group comprising at least one file, the at least one file conforming to a standard image data format, the file group containing image data of a previously displayed image and its operational state data; and in response thereto reloading the image data and displaying the associated image and restoring the computer program product to a state corresponding to the stored operational state data.

The method may further comprise: reloading a source data set pointed to by the stored file so as to allow interactive user adjustment of the operational state conditions starting from those prevailing at the time of storage of the reloaded image.

Another aspect of the invention provides a computer-implemented method, comprising: running a computer program product for image manipulation of source data sets on a computer apparatus; allowing user selection of stored operational state data associated with a previously stored set of image data; and applying at least a subset of the operational state data to another set of image data loaded in or accessible to the computer program product.

Another aspect of the invention provides a file archive comprising a plurality of files conforming to a standard image data format in which the files contain a header portion and an image data portion, wherein the plurality of files is made up of a plurality of file groups, each file group comprising at least one file, wherein, in those file groups with multiple files, each file of the group is linked by association, wherein each file group contains image data stored in an image data portion of at least one of the files of the file group, and operational state data, relating to image view settings pertaining at the time the file group was stored, stored in a header portion and/or an image data portion of at least one of the files of the file group.

Each file group may be linked by association to a source data set representing an object volume.

There may be at least one file group in which operational state data is stored in an image data portion of one of the files of the file group.

Another aspect of the invention provides a method of transferring a file group between locations in a computer network that supports file transfer of files conforming to a standard image data format, the method comprising: providing a file group comprising at least one file, the at least one file conforming to the standard image data format in which the files contain a header portion and an image data portion, the file group containing image data stored in an image data portion of at least one of the files of the file group, and operational state data, relating to image view settings pertaining at the time the file group was stored, stored in a header portion and/or an image data portion of at least one of the files of the file group; and transmitting the file group from a first location in the network to a second location in the network.

It will also be understood that the image data can be transferred over the network independently of the other file group members, i.e. so-called supplementary files, for conventional use.

At least part of the operational state data may be stored in a different file of the file group than the image data. At least a part of the operational state data may be stored in an image data portion of a file of the file group.

By way of example, in a medical application, the present invention allows the following modalities of use:

Physician A runs image manipulation software on a computer workstation until some diagnostically useful images and/or measurements are achieved.

Physician A uses a “live image capture” tool to record one or more of the images currently displayed by the workstation. A thumbnail of the image is generated and marked as “live”.

Physician A can continue to use the workstation for work on the same study. At any time the physician can select and “restore” the thumbnail of the live image. The image manipulation software immediately returns to the state it was when the image was captured.

Physician A can turn off the workstation at the end of the working day, or can close the current study and open a new study. In either case, the original and captured images of the first study are removed from memory. Later, Physician A or Physician B can locate the live image through the user interface of the image manipulation software (usually referred to as an image browser) and restore it. The workstation loads all the necessary original image data and re-creates the state it had when the live image was captured, in respect of those operational state conditions that are saved in the operational state data.

Physician A can export the live image to an image archive based on a standard image data format, such as DICOM, on the hospital network using the facilities that the workstation has to export regular medical images. The live image remains associated with the original study using the standard mechanisms for association that the archive has.

Physician A or Physician B can locate and restore the captured image from any suitably equipped workstation or other device connected to the archive over the network. When the live image is restored, the workstation will load all the original medical image data from the archive and re-create the state that the image manipulation software had in the original workstation when the image was saved.

### BRIEF DESCRIPTION OF THE DRAWINGS

For a better understanding of the invention and to show how the same may be carried into effect reference is now made by way of example to the accompanying drawings, in which:

FIG. 1 is a schematic diagram showing an exemplary network of diagnostic devices and associated equipment;

FIG. 2 is a schematic diagram representing the internal structure of a file which conforms to the DICOM standard;

FIG. 3 is a flow diagram representing the saving of image data and operational state data relating to an image created by manipulation of a source data set using data manipulation software according to an embodiment of the invention;

FIG. 4 is an example screen shot of a computer running image manipulation software according to an embodiment of the invention;

FIG. 5 is an example screen shot of a supplementary DICOM file containing operational state data in its image data portion, as generated according to an embodiment of the invention;

FIG. 6 is a flow diagram representing the loading of a stored image together with restoring operational state conditions that the image manipulation software had when the image was stored according to an embodiment of the invention;

FIG. 7 is a flow diagram showing a process similar to that of FIG. 6 according to an alternative embodiment of the invention;

FIG. 8 is a flow diagram representing a first application of the invention;

FIG. 9 is a flow diagram representing a second application of the invention;

FIG. 10 is a flow diagram representing a third application of the invention; and

FIG. 11 is a flow diagram representing a fourth application of the invention.

### DETAILED DESCRIPTION

Embodiments of the present invention will be described hereinafter and in the context of a computer-implemented system, method and computer program product. Although some of the present embodiments are described in terms of a computer program product that causes a computer, for example a personal computer or other form of workstation, to provide the functionality required of some embodiments of the invention, it will be appreciated from the following description that this relates to only one example of some embodiments of the present invention. For example, in some embodiments of the invention, a network of computers, rather than a stand-alone computer, may implement the embodiments of the invention. Alternatively, or in addition, at least some of the functionality of the invention may be implemented by means of special purpose hardware, for example in the form of special purpose integrated circuits (e.g., Application Specific Integrated Circuits (ASICs)).

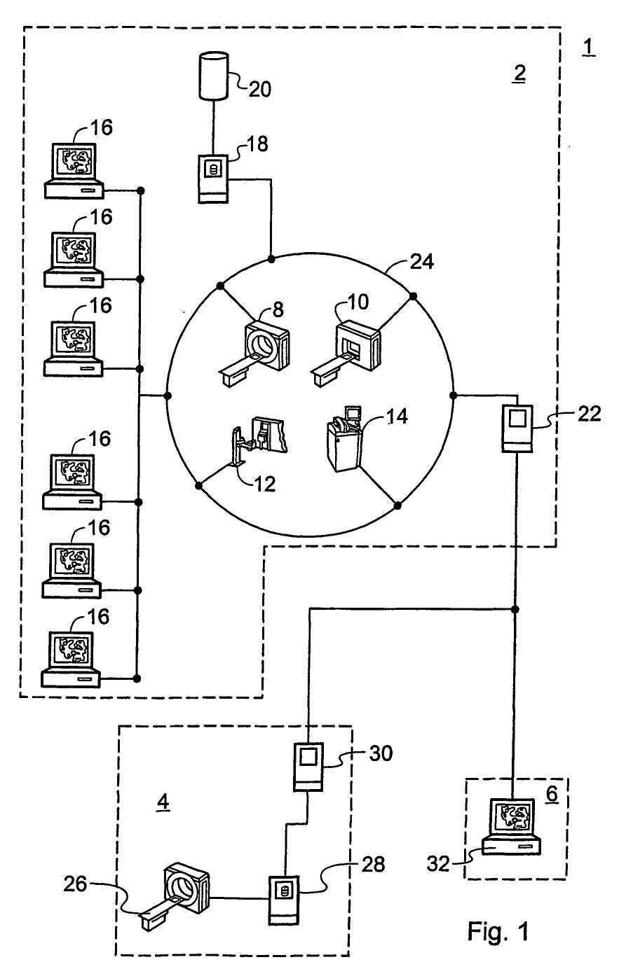

FIG. 1 is a schematic representation of an exemplary network 1 of computer controlled diagnostic devices, stand-alone computer workstations and associated equipment. The network 1 comprises three components. There is a main hospital component 2, a remote diagnostic device component 4 and a remote single user component 6. The main hospital component 2 comprises a plurality of diagnostic devices, in this example, a CT scanner 8, a MR imager 10, a DR device 12 and a CR device 14, a plurality of computer workstations 16, a common format file server 18, a file archive 20 and an internet gateway 22. All of these features are inter-connected by a local area network (LAN) 24.

The remote diagnostic device component 4 comprises a CT scanner 26, a common format file server 28 and an internet gateway 30. The CT scanner 26 and file server 28 are commonly connected to the internet gateway 30, which in turn is connected via the internet to the internet gateway 22 within the main hospital component 2.

The remote single user component 6 comprises a computer workstation 32 with an internal modem (not shown). The computer workstation 32 is also connected via the internet to the internet gateway 22 within the main hospital component 2.

The network 1 is configured to transmit data within a standardised common format. For example, the CT scanner 8 initially generates a source data set, i.e. a 3-D image data set, from which an operator may derive an appropriate 2-D image. The 2-D image is encoded in a standard image data format and transferred over the LAN 24 to the file server 18 for storage on the file archive 20. A user working on one of the computer workstations 16 may subsequently request the image, the file server 18 will retrieve it from the archive 20 and pass it to the user via the LAN 24. Similarly, a user working remotely from the main hospital component 2, either within the remote diagnostic device component 4, or the remote single user component 6, may also access and transmit data stored on the archive 20, or elsewhere on the network 1.

The software operating on or from the computer workstations 16, 32 is configured to conform to the common image data format. The standardisation of the image data format ensures that different software applications on the computers 16, 32, the file servers 18, 28 and file archive 20 and the output from the different computer controlled diagnostic devices 8, 10, 12, 14, 26 can share image data.

The preferred image data format currently employed for medical applications is the “Digital Imaging and Communications in Medicine” format, usually referred to as DICOM. The DICOM standard is published by the National Electrical Manufacturers' Association of America.

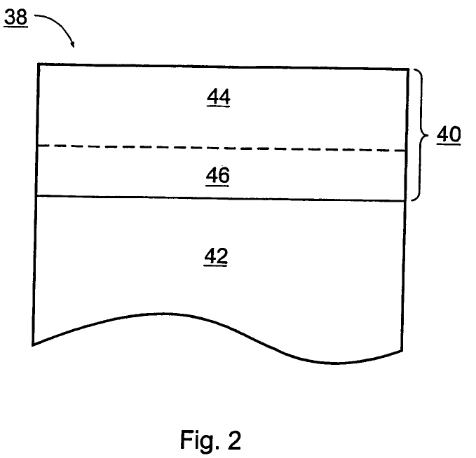

FIG. 2 is a schematic representation of a computer file 38 which is conformant to the DICOM standard. The computer file 38 contains a header portion 40 and an image data portion 42. The header portion 40 is divided into a first header portion 44 and a second header portion 46. The DICOM standard provides the image data portion 42 for storage of the data comprising an image in a standard image data format, and the header portion 40 for storage of ancillary data associated with the image. The first header portion 44 is provided for storage of details which are commonly used and explicitly specified in the DICOM standard. These details are divided into modules such as; patient module, visit module, study module, results module, interpretation module, common composite image module, modality specific module. Within these modules, the inclusion of individual details may be mandatory, conditional or optional. The second header portion 46 is provided for storage of user specific information and comprises what are commonly called private tag information. These can be any details which a user would like to store with an image, but which are not specifically provided for by the DICOM standard for inclusion in the first header portion 44. A typical maximum size for the header portion 40 is 16 kilobytes and this limits the volume of information which may be stored there.

As described above, a drawback of diagnostic device networks and the necessary conformance to a common standard, such as DICOM, is that the network is often incapable of transmitting other details which might be of benefit. The diagnostic devices themselves, file servers, file archives and computers are all designed to communicate by the transfer of DICOM format files. There is often a large amount of additional data that a user may wish to transfer and associate with a particular DICOM image file. This data may include, for example, detailed information on the specific manipulation processes employed in deriving the current 2-D image from the original 3-D data set, instructional information for technicians, further illustrative images and a comprehensive report of the physician's findings. Currently, this information, which shall hereinafter be referred to as the operational state data, must be transferred separately and by a different protocol.

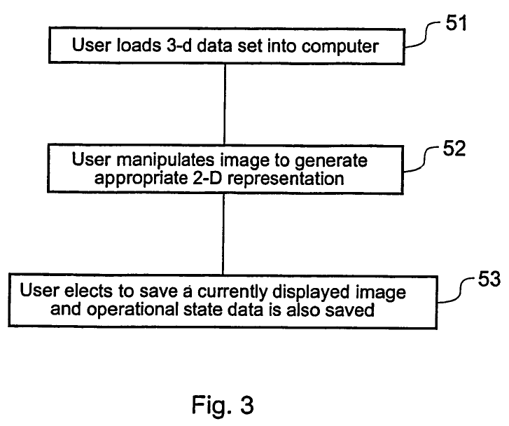

FIG. 3 is a flow diagram which schematically shows a process of saving operational state data.

In a first step 51, a user loads a 3-D data set which has been previously recorded, for example by a CT device, into a computer which is operatively configured to allow manipulation of the 3-D data set. The computer, in this example, is configured to provide a user interface with which the user is already largely familiar, but with the extra functionality of the invention additionally included.

In a second step 52, the user manipulates the 3-D data set to provide a 2-D image in a manner with which they are already accustomed. This manipulation may include steps such as selecting a viewing direction to define the orientation of the 2-D image, identifying and highlighting regions within the image, generating segmentation images, selecting the parameters for volume rendering algorithms and so on. Additionally, the manipulation may involve identifying a plurality of 2-D images which together may be run as a movie to assist in highlighting specific medical findings.

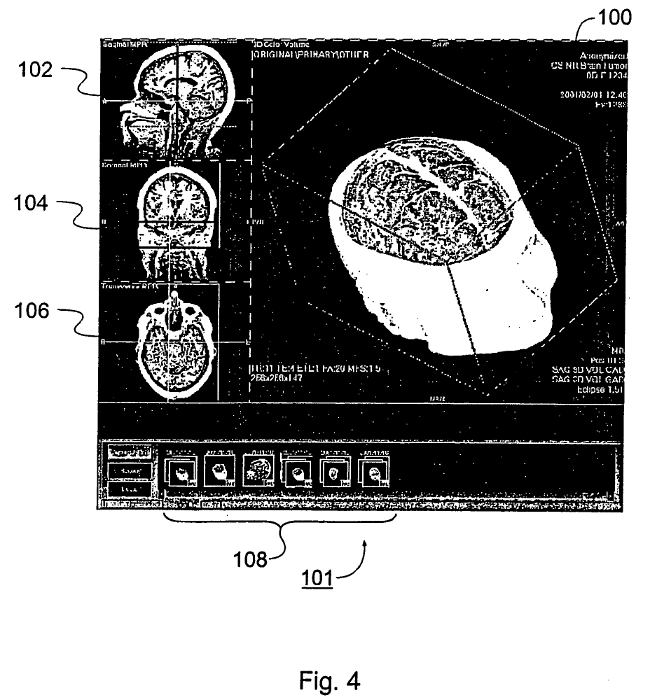

In a third step 53, the user elects to save the 2-D image, as now described in more detail with reference to FIG. 4.

FIG. 4 shows an example screen shot of a display 101 of a 2-D image generated from a 3-D data set. A main image 100 displays the chosen 2-D image. The main image 100 shown in the figure also contains a partial wire-frame cuboid to assist in interpreting the orientation of the image with respect to the original 3-D data, and some basic textual information, such as the date and time. The display 101 also contains a sagittal section 102, a coronal section 104 and a transverse section 106 of the 3-D data to assist in diagnostic interpretation. The main image 100 represents the image that would be written to a standard DICOM file in the prior art. Many useful details, such as, for example, the specific manipulation process employed in generating the image and the section images 102, 104, 106 become disassociated from the 2-D image in this process. In this embodiment, the main image data portion 100 of the display 101 shown in FIG. 4 is written to a standard DICOM file and referred to as the live image. However, in addition to the live image file, a supplementary DICOM file is generated, and those details which would otherwise be lost, are written to it. Details of the storage location of the supplementary DICOM file are included within the header portion 40, as indicated in FIG. 2, of the live image file. There is a large range of additional data that the user might wish to record. For example, in addition to the specific 2-D image, the user may consider it appropriate to store details about some or all of the following:

Layout and types of views displayed on the screen.

Overall state of the user interface presented to the user, including operation mode.

State of graphical user interface elements that control parameters of visualisation.

State of annotations and measurements.

Medical volume or multi-frame image data.

Medical image data.

Medical signal data acquired over time.

Medical discrete measurement data.

The name, age, and other details that identify the patient.

Information that identifies the hospital, physician, type of procedure, and other details of the case.

Additional medical observations or measurements entered directly.

Information about the medical history of the patient.

Report information, comprising text, images, measurements, and references linking findings to particular locations in the patient.

Other readable information, for example instructions or comments from one medical professional to another.

Unique identifier of images or other data objects containing the original medical data.

Study number, series number, acquisition number, or other administrative data that identifies the original medical data.

File names, URLs, network server identifications, or related data that describes the location of the original medical data.

Opacity and colour parameters for volume rendering.

Threshold parameters for surface rendering.

Tissue segmentation and/or selection information.

Fiducial or other registration information.

Clipping information.

Lighting, projection mode, and viewpoint information.

Position, orientation, and thickness of all additional section planes.

Position, orientation, and thickness of all relevant curves and curved surfaces.

Brightness and contrast information.

Tissue segmentation and/or selection information.

Pan and zoom information.

State of movie and still image capture.

Number of frames, rendering type, and geometric and other properties of movie sequence.

Location and rendering properties of captured images.

Any other details suited to the case in hand.

Those data which the user wants to record are first converted to a binary stream. The supplementary DICOM file is created and may, for example, correspond to a fixed width, height and bit-depth commonly used in medical imaging, such as a 512×512×16-bit grey scale. The portion of the supplementary DICOM file which corresponds to the image data portion 42, as indicated in FIG. 2, defined in the DICOM standard may preferentially contain a user-readable notice alerting the user to the fact the file contains valuable data and should not be deleted or modified, e.g. by compression, although it does not contain a viewable image. The binary data stream representing the additional data which the user wants to record is written to the remainder of the image data portion of the supplementary DICOM file. Optionally, a colour palette may be selected for the supplementary DICOM file which appears muted should a user attempt to view the supplementary DICOM file. Muting can also be achieved by restricting the data stored to lie within a reduced range or bits per image pixel. If required, an identifier can be written into the second header portion 46, as indicated in FIG. 2, of the supplementary DICOM file to specifically identify it as being a supplementary DICOM file, and alert co-operative computer workstations that the image should not be displayed. If the volume of data to be stored is sufficiently large, it may be necessary to create more than one supplementary DICOM file to be associated with a particular 2-D image. Conversely, if the volume of data to be stored is sufficiently small, it may be possible to store the data within the second header portion 42, as indicated in FIG. 2, of the live image file and avoid the need to generate a separate supplementary DICOM file.

In one embodiment, for a given capture, the image data is stored in one file and the operational state data is stored in one or more supplementary files. The segmentation data is typically quite voluminous. This is therefore stored in the image data portions of the supplementary files. The remaining operational state data is stored in the headers, i.e. in the proprietary tags in the case of a DICOM format file. In this embodiment, the header of the file containing the image data does not contain operational state data, but merely pointers to the supplementary files, and the source data set. With this embodiment, the image data and the operational state data are separated out into different files. This is convenient, since it allows the file containing the image data to be used as a conventional image data file. Moreover, it allows the operational state data contained in the supplementary files to be applied to a different source data set. The saved operational state data can thus be used as a preset for other images. For example, the presets may be used to apply view settings such as opacity and contrast window settings generated for one CT image of a patient prior to surgery to be used again to a similar image taken after surgery.

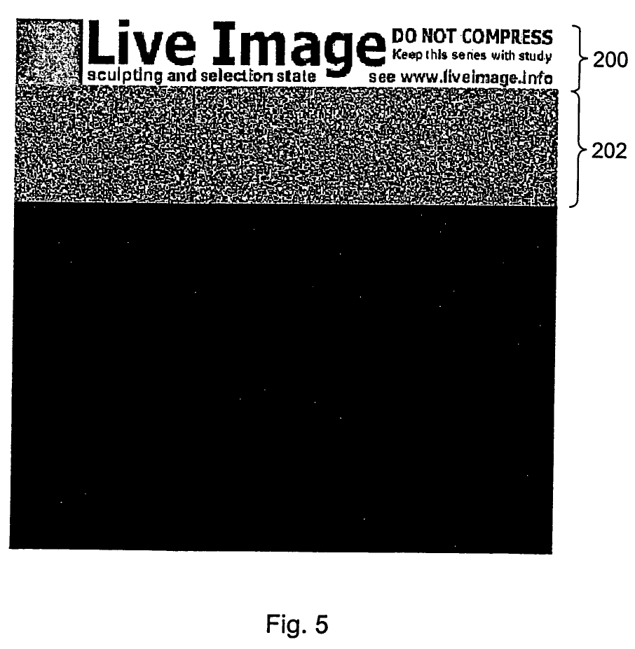

FIG. 5 is a screen shot of an example supplementary DICOM file loaded into the image browser of the software. An upper portion 200 appears as a marker to alert the user as to the nature of the file. A middle portion 202, which corresponds to that portion of the file containing the binary data stream representative of the additional data, appears as a random noise pattern. A lower portion, which in this example is not required for data storage, appears blank.

According to a further embodiment of the invention, the live image file may be configured according to the DICOM standard to contain more than one image. The additional images being supplementary images similar to those described above, but not being written to a separate supplementary DICOM file.

It is understood that the process of image manipulation and saving according to embodiments of the invention may be performed by a user operating a diagnostic device, such as a CT scanner, as the 3-D data are acquired, and not necessarily by a user loading previously recorded 3-D data into a remote computer.

A major benefit of saving the additional data in a supplementary DICOM file is that by conforming to the DICOM standard, both the 2-D image files and associated data files can be stored and communicated within any pre-existing and proprietary architecture designed to operate with the DICOM format. The standard DICOM file and the supplementary DICOM file may be stored locally, or passed to a DICOM file server for archiving. The server and associated archive may comprise a general purpose network file server, a DICOM storage service class provider, an internal or public website or a magnetic, optical or other long term storage medium. The server and associated archive may also be configured to fully support and maintain beneficial file associations and include multiple copies of files to provide a level of redundancy protection.

After saving the data, the user can resume operation and further manipulation of the 3-D data set. The live image appears in any image snapshot area or image browser that the computer user interface provides and can also be made available to other diagnostic devices or computers connected to the network. Such an image snapshot area, containing six snapshot images 108, is shown towards the bottom of the screen display 101 shown in FIG. 4.

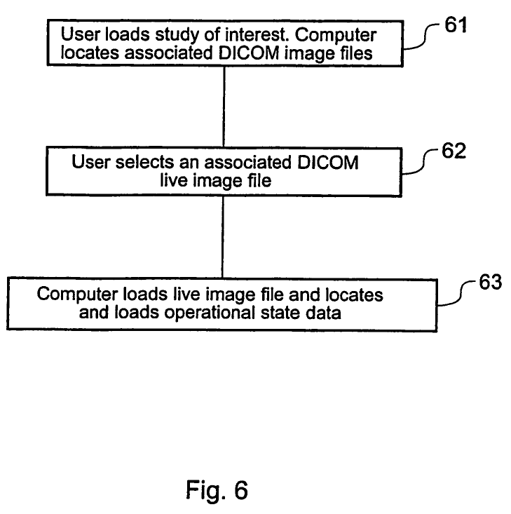

FIG. 6 is a flow diagram which indicates a process of restoring a live image and the associated operational state data.

In a first step 61, a user loads the study of interest, in this case employing the same computer system and software outlined above, as if viewing for the first time. The step 61 is similar to the first step 51 shown in FIG. 5 and the computer display will be similar to that shown in FIG. 4, however, the particular representative 2-D image within the main image data portion 100 of the screen display 101 will be a pre-defined default. In addition to loading the original 3-D image data, the previously generated 2-D images are also identified by the software, using the standard DICOM demographic association techniques, and snapshots of these previously generated 2-D images appear as indicated by the snapshots 108 within the screen display 101 shown in FIG. 4.

In a second step 62, the user selects one of the previously generated live images from the snapshots 108 for restoration. If the display does not provide a general purpose DICOM image browser such as shown in FIG. 4, an image may need to be chosen with a special-purpose browser.

In a third step 63, the computer extracts information stored within the header portion 40 of the selected live image DICOM file. The computer uses the extracted information to identify and locate any additional supplementary DICOM files where the binary stream of the saved operational state is stored as pixel data. The computer retrieves these images from the DICOM archive, extracts and reads the binary stream, re-creates the saved operational state and resumes operation. The operational state of the computer is now restored with full functionality, for example undo-last-step facilities, to its state prior to saving.

Alternatively, in cases where the header portion 40 of the live image is sufficiently large to store the required operational state data, there are no associated files to locate, and the computer uses the details stored in the header portion 40 to re-create the saved operational state.

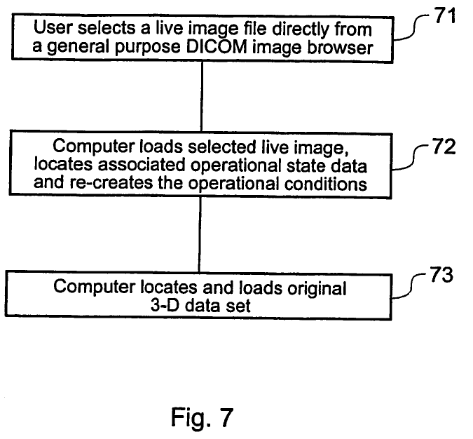

FIG. 7 is a flow diagram which indicates an alternative process of restoring a saved state. In a first step 71, a user selects a live image from a general-purpose DICOM image browser. In this scenario, the computer either has no study loaded, or an unrelated study is loaded. If an unrelated study is currently loaded, it may be closed for simplicity or to save memory. In a second step 72, the computer loads the selected live image, and extracts the information from the header portion 40. If the header portion 40 contains all of the necessary operational state data, the operational state is re-created, in addition the location of the relevant original 3-D data set is identified. However, if there are any associated supplementary DICOM files, details in the header portion 40 indicate the location of these files and they are loaded to allow re-creation of the original operational state. The location of the original 3-D data set is also identified. In a third step 73, the computer retrieves and loads the original data of the study based on the identified location information. This allows the user to further manipulate the image.

The ability to save and restore operational state data as described above can greatly assist a user in a number of situations. For example, it can be used to allow a user to return to a session which has been interrupted, perhaps by a more pressing case, to return to a session on a different computer in a different location, to save more comprehensive details as part of a patient's formal medical records and to automatically regenerate a session after system shut down. The invention can also be advantageous for medical education by storing an operational state which may include annotations, demonstration of the pathology (or other relevant parts of the data), which can then be reviewed by trainees as explanations contained within the larger 3-D data set. It can also assist in providing a graphical or image representation of the entire DICOM data set within an archive or other storage system.

The store facility, such as indicated in the last step 53 of FIG. 3, can also be invoked automatically in response to certain events to prevent loss of a user's work. For example, the operational state may be automatically saved on manual shut down of a diagnostic device or stand-alone computer workstation, when there is a need to rapidly open a second study, perhaps in response to a medical emergency, when there is a need to rapidly store all data, perhaps in response to an impending power failure or simply periodically as part of a regular back up procedure.

In general, the operational state data will not save all the operational state conditions pertaining at the time of image storage, but only a selected subset of them.

For example, in the case of a CT diagnostic device with 3-D rendering capabilities, the following operational state conditions would typically be those that one would consider saving in the operational state data:

The DICOM unique identifications of all of the original CT images currently loaded.

The layout of views and operation mode of the user interface.

The geometries of identified regions, and any 3-D clipping planes and/or clipping surfaces.

The geometries of any segmented, selected, and/or removed regions of the volume.

The opacity, colour, projection mode, orientation, and lighting settings used for volume rendering.

The location and geometry of all Multi-Planar Reformatting (MPR) planes and MPR surfaces.

The thickness, projection mode, and Window/Level settings of all MPR images.

On the other hand, the following would be operational state conditions one would typically be of lesser interest for saving, since they could be re-created or reloaded when the operational state is restored without much effort:

Original CT images used to construct 3-D or MPR renderings.

The actual layout of views and GUI on the screen, resized to fit the screen of the restoring device.

Look-up tables for colour, opacity, or other attributes.

Rasterised representations of clipping geometry.

Rasterised representations of transparent and/or opaque material.

Reduced-resolution versions of 2-D and 3-D data used to provide temporary, low-quality images.

Rendered 3-D and MPR images.

One useful aspect of the invention is that the original image data (such as slice data from CT or MR scanners) that was being analysed at the time the operational state was saved does not need to be saved as part of the operational state. Instead, appropriate references to these DICOM images are saved, such as unique identification numbers, or study, series, and image numbers and the restoring device fetches the original image data directly from the archive using this information.

Another useful aspect of the invention is that, not only does the storing of operational state data within standard DICOM files ensure easy storage and transfer within pre-existing architecture designed to be conformant with the DICOM standard, but also computer workstations can be especially configured so as to make the operation entirely hidden from the user. A modified computer workstation could, for example, be instructed to never list supplementary DICOM files within its image browsing facility.

Other beneficial features are as follows: ensuring that the live image snapshots icons are thumbnail representations of the stored image, hiding references to the supplementary DICOM files from users who do not wish to see them and ensuring that the supplementary DICOM files are automatically copied, moved, communicated or deleted along with associated live image. Furthermore, it may be desirable to protect any supplementary DICOM files against accidental deletion by alerting a user as to the nature of the file before proceeding to delete it.

In the described embodiments, a computer implementation employing computer program code for storage on a data carrier or in memory can be used to control the operation of the processor of the computer. The computer program can be supplied on a suitable carrier medium, for example a storage medium such as solid state memory, magnetic, optical or magneto-optical disk or tape based media. Alternatively, it can be supplied on a transmission medium, for example a medium with a carrier such as a telephone, radio or optical channel.

It will be appreciated that although particular embodiments of the invention have been described, many modifications/additions and/or substitutions may be made within the scope of the present invention. Accordingly, the particular examples described are intended to be illustrative only, and not limitative.

In particular, the embodiments have referred to creating 2-D images from 3-D volume data. However, it will be understood that the invention can be carried out for creating 2-D images from 2-D data which is acquired by some types of medical imaging apparatus.

Applications

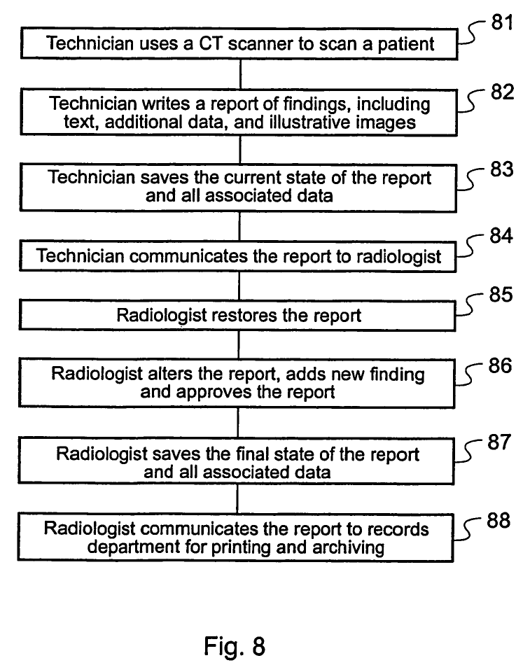

FIG. 8 is a flow diagram which schematically represents a first application of the invention to assist in pre-reporting analysis of 3-D medical data. In a first step 81, a technician uses a CT scanner to scan a patient. In a second step 82, the technician writes a report of their findings, including text, additional data, and illustrative images as appropriate. In a third step 83, the technician saves the current operational state device and all associated data, which together comprise the report. In a fourth step 84, the technician communicates the report to a radiologist. In a fifth step 85, the radiologist restores the report. In a sixth step 86, the radiologist modifies the report as required, adds new finding and approves the final report. In a seventh step 87, the radiologist saves the final state of the report and all associated data. In an eighth step 88, the radiologist communicates the report to a records department for printing and archiving.

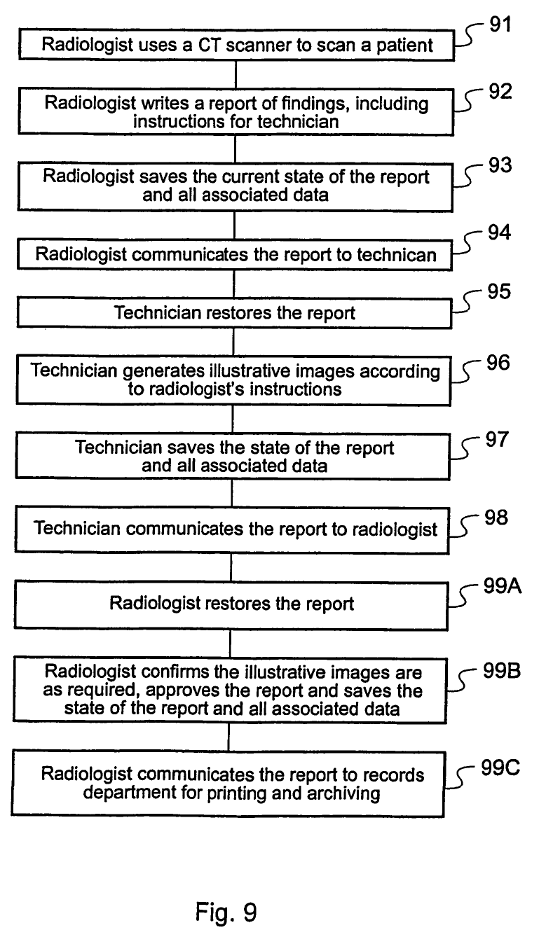

FIG. 9 is a flow diagram which schematically represents a second application of the invention to enable improved post-scan illustration. In a first step 91, a radiologist uses a CT scanner to scan a patient. In a second step 92, the radiologist writes a report of their findings, including instructions to a technician. In a third step 93, the radiologist saves the current state of the report and all associated data according to an aspect of the invention. In a fourth step 94, the radiologist communicates the report to the technician. In a fifth step 95, the technician restores the report. In a sixth step 96, the technician generates illustrative images according to the radiologist's instructions. In a seventh step 97, the technician saves the state of the report and all associated data. In an eighth step 98, the technician communicates the report to the radiologist. In a ninth step 99A, the radiologist restores the report. In a tenth step 99B, the radiologist confirms the illustrative images are as required, approves the report and saves the state of the report and all associated data. In an eleventh step 99C, the radiologist communicates the report to a records department for printing and archiving.

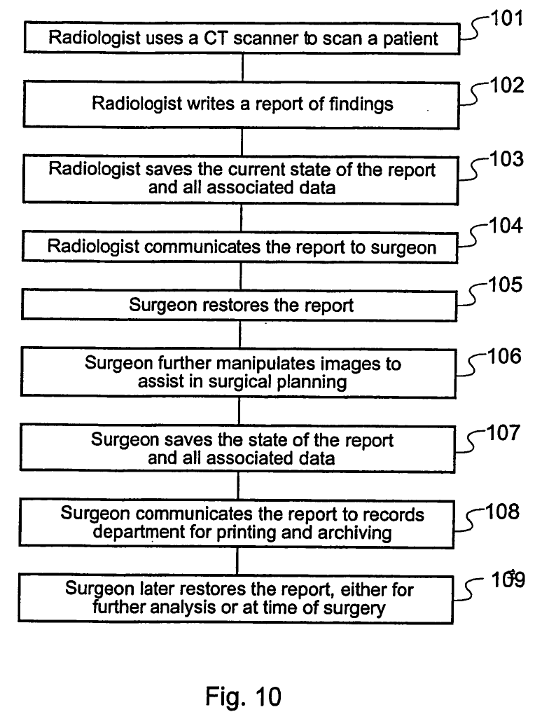

FIG. 10 is a flow diagram which schematically represents a third application of the invention to enable improved surgical planning. In a first step 101, a radiologist uses a CT scanner to scan a patient. In a second step 102, the radiologist writes a report of their findings. In a third step 103, the radiologist saves the current state of the report and all associated data. In a fourth step 104, the radiologist communicates the report to a surgeon. In a fifth step 105, the surgeon restores the report. In a sixth step 106, the surgeon further manipulates the images within the report to assist in surgical planning. In a seventh step 107, the surgeon saves the state of the report and all associated data. In an eighth step 108, the surgeon communicates the report to a records department for printing and archiving. In a ninth step 109, the surgeon later restores the report, either for further analysis, or at the time of surgery.

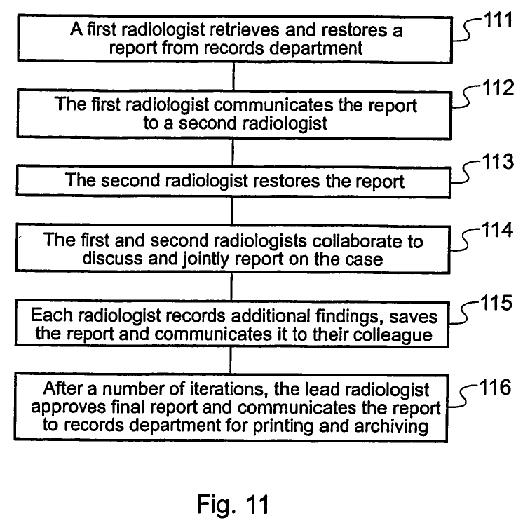

FIG. 11 is a flow diagram which schematically represents a fourth application of the invention to enable improved consultation between users. In a first step 111, a first radiologist retrieves and restores a report from a records department. In a second step 112, the first radiologist communicates the report to a second radiologist. In a third step 113, the second radiologist restores the report. In a fourth step 114, the first and the second radiologists collaborate to discuss and jointly-report on the case. This collaboration process may include situations where the first and second radiologists work together at a particular computer workstation, use the same computer workstation at different times, use different computer workstations at the same time, and perhaps being in further contact by telephone or other communication system or collaborate entirely via comments stored within the report. In a fifth step 115, the first and second radiologists iteratively modify and communicate the report between each other as required. In a sixth step 116, when the first and second radiologists are satisfied with the report, the lead radiologist approves the report and communicates it to a records department for printing and archiving.

Further applications may be readily envisaged. The above-described aspects are intended to provide examples only.

Summary

The present invention allows operational state data to be stored and communicated through any system designed to store and communicate digital image data, including image storage and communication systems that predate the invention. Systems for storing and communicating digital medical image data using the DICOM standard are widespread and expected to eventually completely replace legacy systems.

An additional benefit of the present invention is that it allows a user to operate the operational state storage and communication functionality through existing and familiar user interfaces for capturing, transmitting, and loading medical images. A saved operational state is associated with an ordinary visible images captured from a display output of a computer workstation at the time when the operational state was saved. A saved operational state remains associated with the relevant study through demographic information (such as patient name and study number), as is standard practice for medical images. Furthermore, the user can select to restore a single image with a saved operational state, and a computer workstation enabled with the present invention will fetch and/or regenerate all necessary data to re-create the entire state of the computer workstation at the time the operational state was recorded.

1. A computer program product for image manipulation of a source data set, the product being operable to:
load a source data set for image manipulation by the computer program product;
generate and display image data of the source data set by allowing interactive user adjustment of a plurality of operational state conditions; and
store the image data of a currently displayed image together with operational state data corresponding to at least a subset of its current operational state conditions in a standard image data format.

2. A computer program product according to claim 1, wherein the image data and the operational state data are stored in a single file conforming to the standard image data format.

3. A computer program product according to claim 2, wherein the standard image data format comprises a file structure having a header portion and an image data portion, and wherein the image data is stored in the image data portion, and the operational state data is stored in the header portion.

4. A computer program product according to claim 2, wherein the standard image data format comprises a file structure having a header portion and an image data portion, and wherein the image data and at least a part of the operational state data are stored in the image data portion.

5. A computer program product according to claim 1, wherein the image data and the operational state data are stored in multiple files conforming to the standard image data format which are linked by association.

6. A computer program product according to claim 5, wherein the standard image data format comprises a file structure having a header portion and an image data portion, and wherein the image data is stored in the image data portion of a first one of the multiple files and at least a part of the operational state data is stored in the image data portion of a second one of the multiple files.

7. A computer program product according to claim 6, wherein the second one of the multiple files contains notice data which provides a user-readable notice when the second file is displayed, so that a user is provided with a notification that the second file is not to be deleted.

8. A computer program product according to claim 5, wherein each of the multiple files contain demographic tags to associate them with each other.

9. A computer program product according to claim 4, wherein the operational state data stored in the image data portion has a reduced range of bits per image pixel, to provide a muted image if the operational state data is displayed.

10. A computer program product according to claim 1 further operable to:
allow user selection of a stored file group comprising, at least one file, the at least one file conforming to the standard image data format, the file group containing image data of a previously displayed image and its operational state data; and in response thereto
reload the image data and display the associated image and restore the computer program product to a state corresponding to the operational state data.

11. A computer program product according to claim 10, further operable to:
reload a source data set pointed to by the stored file so as to allow interactive user adjustment of the operational state conditions starting from those prevailing at the time of storage of the reloaded image.

12. A computer program product according to claim 1, wherein the standard image data format is DICOM.

13. A computer program product according to claim 1, wherein the image data comprises a plurality of image frames to be displayed in sequence to generate an animation, the operational state data being generic to the image frames.

14. A computer program product according to claim 1, wherein the source data set is a volume data set.

15. A computer program product according to claim 1, wherein the operational state data comprise at least one of volume rendering parameters; surface rendering parameters; segmentation data; view direction parameters; graphical user interface configuration data; clipping information; and multi-planar reformatting (MPR) parameters.

16. (currently amended) A computer apparatus loaded with a computer program product according to any one of the preceding claims claim 1.

17. A computer-implemented method, comprising:
loading a source data set for image manipulation into a computer apparatus;
generating and displaying image data of the source data set by allowing interactive user adjustment of a plurality of operational state conditions; and
storing the image data of a currently displayed image together with operational state data corresponding to at least a subset of its operational state conditions in a standard image data format.

18. A method according to claim 17, wherein the standard image data format is DICOM.

19. A computer-implemented method, comprising:
running a computer program product for image manipulation of source data sets on a computer apparatus;
allowing user selection of a stored file group comprising at least one file, the at least one file conforming to a standard image data format, the file group containing image data of a previously displayed image and its operational state data; and in response thereto
reloading the image data and displaying the associated image and restoring the computer program product to a state corresponding to the stored operational state data.

20. A method according to claim 19, further comprising:
reloading a source data set pointed to by the stored file so as to allow interactive user adjustment of the operational state conditions starting from those prevailing at the time of storage of the reloaded image.

21. A method according to claim 19, wherein the standard image data format is DICOM.

22. A computer-implemented method, comprising:
running a computer program product for image manipulation of source data sets on a computer apparatus;
allowing user selection of stored operational state data associated with a previously stored set of image data; and
applying at least a subset of the operational state data to another set of image data loaded in or accessible to the computer program product.

23. A file archive comprising a plurality of files conforming to a standard image data format in which the files contain a header portion and an image data portion, wherein the plurality of files is made up of a plurality of file groups, each file group comprising at least one file, wherein, in those file groups with multiple files, each file of the group is linked by association, wherein each file group contains image data stored in an image data portion of at least one of the files of the file group, and operational state data, relating to image view settings pertaining at the time the file group was stored, stored in a header portion and/or an image data portion of at least one of the files of the file group.

24. A file archive according to claim 23, wherein each file group is linked by association to a source data set.

25. A file archive according to claim 23, wherein there is at least one file group in which operational state data is stored in an image data portion of one of the files of the file group.

26. A file archive according to claim 23, wherein the standard image data format is DICOM.

27. A method of transferring a file group between locations in a computer network that supports file transfer of files conforming to a standard image data format, the method comprising:
providing a file group comprising at least one file, the at least one file conforming to the standard image data format in which the files contain a header portion and an image data portion, the file group containing image data stored in an image data portion of at least one of the files of the file group, and operational state data, relating to image view settings pertaining at the time the file group was stored, stored in a header portion and/or an image data portion of at least one of the files of the file group; and transmitting the file group from a first location in the network to a second location in the network.

28. A method according to claim 27, wherein at least part of the operational state data is stored in a different file of the file group than the image data.

29. A method according to claim 27, wherein at least a part of the operational state data is stored in an image data portion of a file of the file group.

30. A method according to claim 27, wherein the standard image data format is DICOM.
